(19) United States
(12) Patent Application Publication
(10) Pub. No.: US 2005/0091167 A1
(43) Pub. Date: Apr. 28, 2005

(54) Interdiction of unauthorized copying in a decentralized network

(75) Inventors: James Moore, Santa Clara, CA (US); William Bland, Santa Clara, CA (US); Scott Francis, Santa Clara, CA (US); Neil King, Santa Clara, CA (US); James Patterson, Santa Clara, CA (US); Usha Srinivasan, Santa Clara, CA (US); Paul Widden, Santa Clara, CA (US)

Correspondence Address: PATENT DEPARTMENT;MACROVISION CORPORATION, 2830 DE LA CRUZ BLVD., SANTA CLARA, CA, 95050, US

(73) Assignee: MACROVISION CORPORATION, SANTA CLARA, CA (US)

(21) Appl. No.: 10/803,784

(22) Filed: Mar. 18, 2004

Related U.S. Application Data
(60) Provisional application No. 60/514,430, filed on Oct. 25, 2003.
(60) Provisional application No. 60/514,429, filed on Oct. 25, 2003.
(60) Provisional application No. 60/518,691, filed on Nov. 10, 2003.
(60) Provisional application No. 60/528,466, filed on Dec. 10, 2003.

(51) Int. Cl. H04K 1/00

(52) U.S. Cl. 705/57

(57) ABSTRACT

An interdiction system includes software agents masquerading as nodes in a decentralized network, a query matcher that receives search results captured by the software agents and reports matches with protected files back to the software agents, and a central coordinating authority that coordinates activities of the software agents by sending instructions to the software agents specifying actions to be taken. Possible activities and related interdicting methods include manipulating search results before forwarding them on in the network, quarantining selected nodes in the network, performing file impersonations such as transferring synthesized decoys, performing file transfer attenuation, and hash spoofing.

### CROSS REFERENCE TO RELATED APPLICATIONS

This application claims priority to U.S. provisional application Ser. No. 60/514,430 filed Oct. 25, 2003; U.S. provisional application Ser. No. 60/514,429 filed Oct. 25, 2003; U.S. Provisional application Ser. No. 60/518,691 filed Nov. 10, 2003 and U.S. provisional application Ser. No. 60/528,466 filed Dec. 10, 2003.

### FIELD OF THE INVENTION

The present invention generally relates to copy protection techniques and in particular, to interdiction of unauthorized copying in a decentralized network.

### BACKGROUND OF THE INVENTION

Unauthorized copying in decentralized networks using peer-to-peer (P2P) file sharing has become a major concern to owners of copyrighted material. Unlike a centralized network, decentralization makes it commercially impractical to pursue all copyright violators in court. This is because decentralization requires filing lawsuits against virtually millions of client computer operators instead of only one party operating a central computer.

Accordingly, copyright owners seek other methods for protecting their copyrighted material, such as blocking, diverting or otherwise impairing the unauthorized distribution of their copyrighted works on a publicly accessible decentralized or P2P file trading network. In order to preserve the legitimate expectations and rights of users of such a network, however, it is desirable that copyright owners do not alter, delete, or otherwise impair the integrity of any computer file or data lawfully residing on the computer of a file trader.

### OBJECTS AND SUMMARY OF THE INVENTION

Accordingly, it is an object of the present invention to provide a method and apparatus for interdiction of unauthorized copying in decentralized networks.

Another object is to provide such method and apparatus so that the legitimate rights and expectations of users of the decentralized network are preserved.

Still another object is to provide such method and apparatus such that the decentralized network is not prevented from operating for legitimate file sharing activities.

Yet another object is to provide such method and apparatus so that copies of files on the decentralized network are not destroyed through erasure or corruption of data.

These and additional objects are accomplished by the various aspects of the present invention, wherein briefly stated, one aspect is a system for interdicting unauthorized copying in a decentralized network. Included in the system are software agents masquerading as nodes in a decentralized network, and a query matcher that receives search results from the software agents, and reports matches of the search results with protected files back to the software agents so that the software agents can interdict unauthorized copying of the protected files in the decentralized network.

Another aspect is a method for interdicting unauthorized copying in a decentralized network, comprising: infiltrating a decentralized network with a plurality of software agents masquerading as nodes so as to intercept communications related to search queries; identifying references to protected files in the communications; and interdicting unauthorized copying of the protected files with respect to the communications.

Yet another aspect is a method for interdicting unauthorized copying in a decentralized network, comprising: interposing one or more software agents resembling nodes between a client node and neighboring nodes of the client node in a decentralized network such that all communications related to search queries must pass through the one or more software agents so as to allow the one or more software agents to interdict unauthorized copying by the client node in the decentralized network.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a node diagram of a non-hierarchical decentralized network.

FIG. 2 illustrates a node diagram of a hierarchical decentralized network.

FIG. 3 illustrates a flow diagram of a method for performing a search query in a non-hierarchical decentralized network.

FIG. 4 illustrates a flow diagram of a method for performing a search query performed by a regular node in a hierarchical decentralized network.

FIG. 5 illustrates a flow diagram of a method for performing a search query performed by a SuperNode in a hierarchical decentralized network.

FIG. 6 illustrates a block diagram of a system utilizing aspects of the present invention for interdicting search queries in a decentralized network.

FIG. 7 illustrates a flow diagram of a method for interdicting search queries through search result manipulation, utilizing aspects of the present invention.

FIG. 8 illustrates a flow diagram of a method for quarantining a node, utilizing aspects of the present invention.

FIGS. 9-12 illustrate nodal diagrams as an example of the method for quarantining a node, utilizing aspects of the present invention.

FIG. 13 illustrates a flow diagram of a method for interdicting search queries through file impersonation, utilizing aspects of the present invention.

FIG. 14 illustrates a flow diagram of a method for interdicting search queries through file transfer attenuation, utilizing aspects of the present invention.

### DETAILED DESCRIPTION OF THE PREFERRED EMBODIMENT

In a decentralized network, there is no central authority or managing entity. Each node of the network makes decisions autonomously to connect, disconnect, and share information with other nodes in the network according to a predetermined protocol established by the creators of the network. Files and documents are stored in the nodes of the networks and propagated throughout the network via inter-nodal exchange. Users search the network using search queries at their respective nodes for specific files or documents and then select a host from search results to download or stream the content from.

To prevent downloading of protected files, various methods for search result manipulation and interdiction are described herein. These methods vary to some extent by the type of file sharing network that they are operating in. To illustrate the various aspects of the present invention, two networks, respectively referred to as Type A and Type B networks, are used as examples throughout the following description.

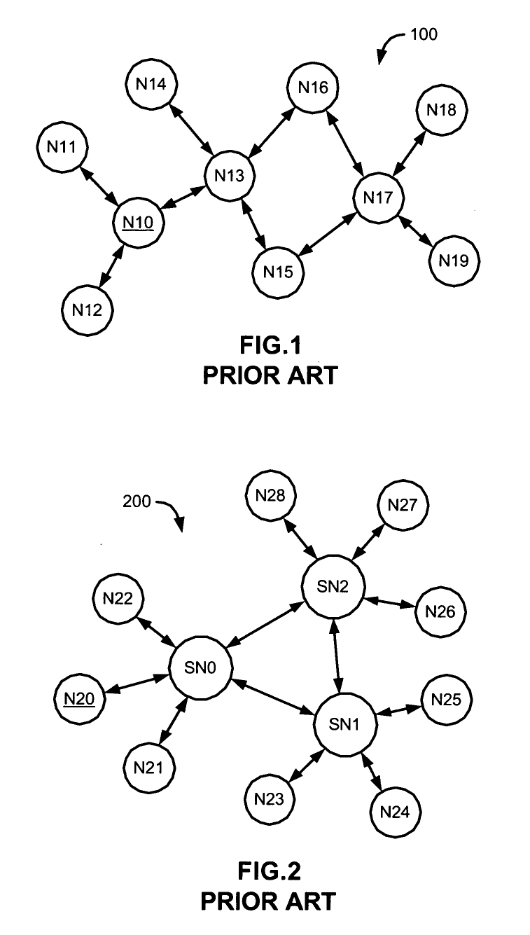

FIG. 1 illustrates, as an example, a node diagram of a Type A, non-hierarchical decentralized network 100. In this network structure, all nodes such as nodes N11˜N19 are treated as equals. FIG. 2, on the other hand, illustrates, as an example, a node diagram of a Type B, hierarchical decentralized network 200. In this second network, there are regular nodes such as nodes N20˜N28, and so-called SuperNodes such as SuperNodes SN0˜SN2. Regular nodes represent computers hooked to the network 200 that host or are capable of hosting files for sharing. SuperNodes are computers hooked to the network 200 that not only host or are capable of hosting files for sharing, but also have higher resources than regular nodes and generally perform functions in addition to those of regular nodes.

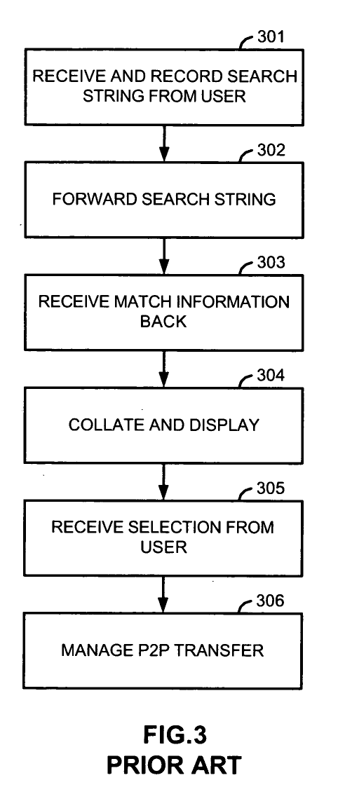

FIG. 3 illustrates a flow diagram of a method for performing a file or document search in a Type A, non-hierarchical decentralized network such as the network 100. In 301, when a user of a node (such as node N10 in FIG. 1) initiates a search by generating a search (or keyword) string, the node operated by the user (hereinafter referred to as the “client node”) receives and records that search string. In some systems, the name of a file that is being requested is hashed to get a key or hash value, and the key or hash value is sent out in the search string for matching.

In 302, the client node then forwards the search string to other nodes in the decentralized network. It may do this, for example, by forwarding the search string to one or more of its neighboring nodes (i.e., nodes that it is in communication with through the decentralized network software, such as nodes N1, N12 and N13 with respect to node N10 in FIG. 1), which in turn, forward the search string to their neighboring nodes (such as nodes N14, N15 and N16 with respect to node N13 in FIG. 1), and so on, throughout the decentralized network. Note that the precise behavior of the search string handling, forwarding and query match returning process depends on the defined rules and/or policies of the decentralized network.

Each node receiving the search string checks its file list for matches, and sends information of any query matches back through the decentralized network so as to be received by the client node in 303. Information of the query matches includes information on how to locate the file such as an URL. Hash values for each of the references (i.e., files or documents) may also be sent in the query matches. All query matches (also referred to herein as “search results”) are generally sent back along the path that they came.

In 304, all received query matches are collated and displayed on a display screen by the client node for its user. In 305, the client node receives a selection (i.e., file or document) indicated by its user, and in 306, it manages a P2P transfer with the selected file's host node(s). For example, the client node may establish a direct connection with the node(s) having a copy of the selection available for download, and sends an HTTP request to those node(s) requesting the selection. The node(s) may then reply with a standard HTTP response.

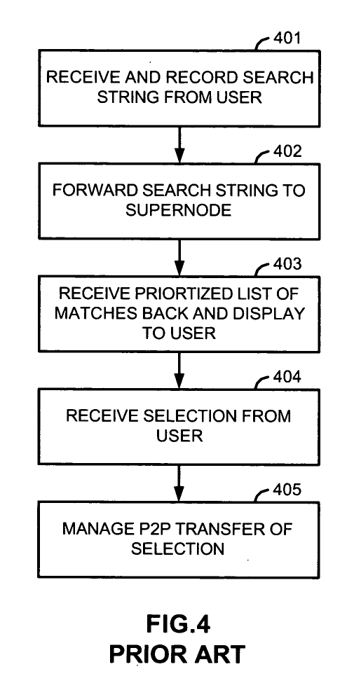

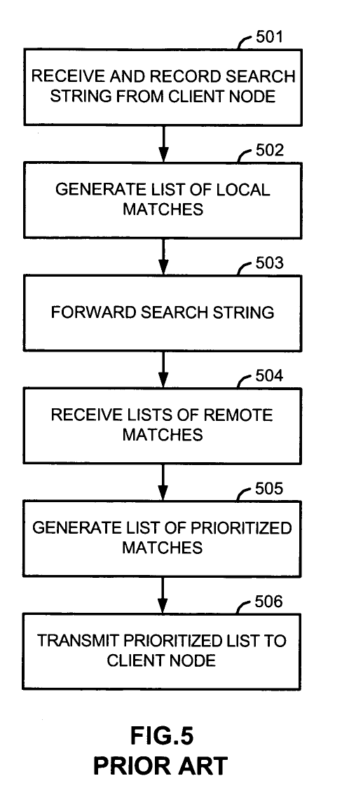

FIGS. 4-5 illustrate a flow diagram of a method for performing a search query in a Type B, hierarchical decentralized network such as the network 200. In particular, FIG. 4 illustrates actions taken by a client node initiating the search string (such as node N20 in FIG. 2), and FIG. 5 illustrates corresponding actions taken by a SuperNode (such as SuperNode SN0 connected to node N20 in FIG. 2) receiving the search string.

Referring now to FIG. 4, in 401, when a user of a node (such as node N20) initiates a search by generating a search (or keyword) string, the node operated by the user (i.e., the “client node”) receives and records that search string. In 402, the client node then forwards the search string to a SuperNode (such as SN0), which in turn, performs activities described in reference to FIG. 5. In 403, the client node receives a prioritized list of matches back from the SuperNode and displays it on a display screen of the client node. In 404, the client-node receives a selection indicated by its user, and in 405, it manages a P2P transfer with the selected file's host node(s) in much the same fashion as described in reference to 305 of FIG. 3.

Referring now to FIG. 5, in 501, a SuperNode receives and records the search string from the client node. In 502, it checks the search string against its file list, which includes files that it hosts as well as files available on other nodes connected to it (such as regular nodes N22 and N21 connected to SuperNode SN0) to generate a list of local matches. In 503, it forwards the search string to all or a subset of SuperNodes connected to it (such as SuperNodes SN1 and SN2 connected to SuperNode SN0). These SuperNodes may in turn forward the search string to other SuperNodes connected to them, and so on, wherein the number of levels the search string is forwarded depends on the defined rules and/or policies of the decentralized network.

Each of the SuperNodes receiving the search string then checks its file list for matches, and sends information of query matches (as lists of local matches) back through the decentralized network so as to be received by the original SuperNode in 504. In 505, the original SuperNode (i.e., the SuperNode first receiving the search string) then generates a list of prioritized matches from all the lists of local matches (including its own). Prioritization in this case is commonly done, for example, by connection speed and quality of the file. Finally, in 506, the prioritized list of matches is transmitted back to the client node from which the search string originated.

Additional details on decentralized networks may be found from publicly available information for decentralized peer-to-peer technologies and protocols such as Freenet, GNUtella, and Fastrack, wherein detailed knowledge of each such decentralized network is useful in implementing the various aspects of the present invention.

Interdiction System

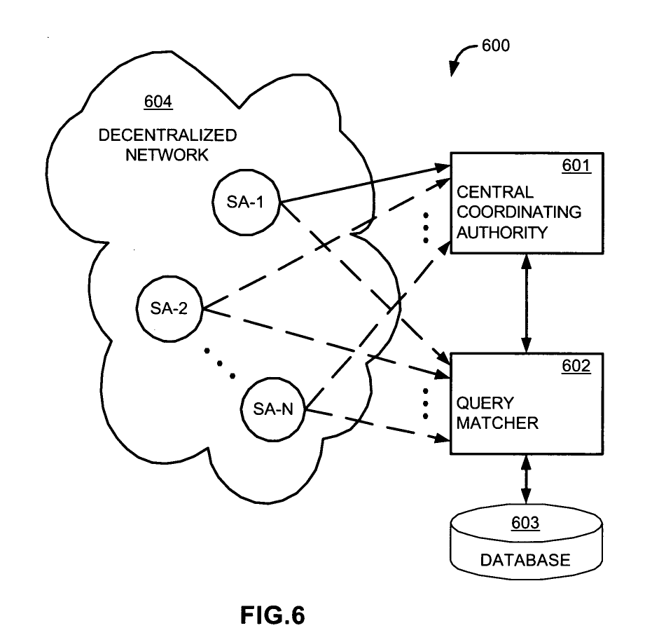

FIG. 6 illustrates a block diagram of a system 600 for interdicting unauthorized copying in a Decentralized Network 604. A plurality of Software Agents SA-1 to SA-N are infiltrated into the Decentralized Network 604 masquerading as nodes by following all the traditions and policies of the Decentralized Network 604 so that they are virtually indistinguishable as infiltrators.

The Software Agents SA-1 to SA-N are implemented as software residing on one or more computers that communicate with nodes in the Decentralized Network 604 through individually assigned ports of the one or more computers. IP addresses for the ports may vary with time or in some other manner so that detection of the Software Agents SA-1 to SA-N as unauthorized masqueraders of nodes in the Decentralized Network 604 and their expulsion from the Network 604 are prevented or at least made considerably more difficult.

The Software Agents SA-1 to SA-N may uniformly infiltrate the Decentralized Network 604 by, for example, each of the Software Agents SA-1 to SA-N connecting to a corresponding node of a representative set of nodes in the Decentralized Network 604. The representative set of nodes in this case is a subset of the Decentralized Network 604 from which characteristics of the entire Decentralized Network 604 may be statistically inferred.

General steps used by the Software Agents SA-1 to SA-N to infiltrate the Decentralized Network 604 include making Internet connections to other nodes in the Decentralized Network 604, performing handshakes or login procedures with those other nodes as specified by the protocol of the Decentralized Network 604 in order to be recognized as nodes of the Decentralized Network 604, and conducting searches and performing operations that regular nodes routinely do in the Decentralized Network 604 while clandestinely also performing interdiction functions.

In addition, if the Software Agents SA-1 to SA-N are to masquerade as Supernodes in the Decentralized Network 604, they also inform the Decentralized Network 604 that they are Supernodes upon logging in and/or they are configured or at least inform the Decentralized Network 604 that they are configured to meet all of the criteria for a Supernode according to the policies of the Decentralized Network 604.

In order to perform the above infiltration, it is useful to first identify nodes in the Decentralized Network 604 that the Software Agents SA-1 to SA-N can make Internet connections to. One way to do this is for a node controlled by the interdicting system to first join the Decentralized Network 604 as a regular client by logging in through client application software provided by or otherwise associated with the Decentralized Network 604, receiving addresses of nodes of the Decentralized Network 604 after logging in, and storing the addresses in a node address cache for later use. The node addresses may be provided in an initial list of node addresses received upon logging in, as well as additional node addresses resulting from connecting to one or more nodes in the initial list of nodes.

The number of the Software Agents SA-1 to SA-N, their attributes as reported to other nodes in the Decentralized Network 604, and the geographical locations of the one or more computers upon which they reside are preferably determined by the number and geographical distribution of the nodes of the Decentralized Network 604 so that the Software Agents SA-1 to SA-N receive a desired percentage of search related communications traveling through the Decentralized Network 604.

Each of the Software Agents SA-1 to SA-N receives search queries from client nodes requesting files in the Decentralized Network 604, and forwards those search queries to other nodes in the Decentralized Network 604 so as to behave just like a regular node in this respect. When the Software Agents SA-1 to SA-N receive search results back from those forwarded search queries, however, rather than passing those search results back along the same path that the Software Agents SA-1 to SA-N received the corresponding search queries, they first send the search results to a Query Matcher 602 implemented as software residing on a computer connected to the Software Agents SA-1 to SA-N through a private network.

The Query Matcher 602 compares each of the references in the search results to entries in its own Database 603 containing metadata including content identification codes of protected files. Matches are then sent back to each of the Software Agents SA-1 to SA-N for search results received by the Query Matcher 602 from that Software Agent.

A Central Coordinating Authority 601 implemented as software on a computer coordinates activities of the plurality of Software Agents SA-1 to SA-N so as to interdict unauthorized copying in the Decentralized Network 604. It does this by sending instructions to the plurality of Software Agents SA-1 to SA-N through a private network specifying actions to be taken when the plurality of Software Agents SA-1 to SA-N receive matches of search results with protected files back from the Query Matcher 602.

Search Result Manipulation

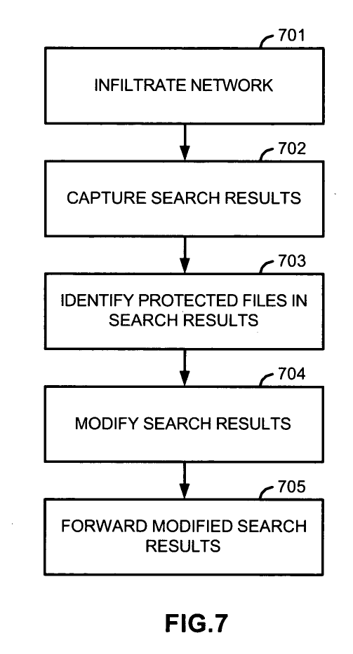

FIG. 7 illustrates a flow diagram of a method for interdicting search queries through search result manipulation. In 701, a Software Agent infiltrates a decentralized network resembling or masquerading as a node along with other Software Agents as described in reference to FIG. 6. The node may be any node in a non-hierarchical network, or it may be a SuperNode in a hierarchical network. In 702, the Software Agent captures search results on their way back to a client node from which its corresponding search string originated.

In 703, the Software Agent identifies files, documents and/or programs that it has been chartered to protect (also referred to herein cumulatively as “protected files”) in the search results. For example, it may do this by sending the search results to a Query Matcher and receiving matches for protected files back from the Query Matcher as previously described in reference to FIG. 6.

In 704, the Software Agent modifies the search results so as to interdict unauthorized copying of the protected files according, for example, to instructions provided to it by a Central Coordinating Authority as previously described in reference to FIG. 6. In 705, the Software Agent then forwards the modified search results through the decentralized network so that it is subsequently received by the client node which originated the corresponding search string.

The Software Agent may employ any one or more of several techniques to modify the search results in 704 so as to interdict unauthorized copying in the decentralized network. In all of these techniques, however, a key feature is that none of the actual files that are residing on nodes in the decentralized network and being made available by those nodes for file sharing are damaged in any way. The techniques only interdict unauthorized copying of protected files in the decentralized network.

One such technique to modify the search results in 704 is to simply delete all or a subset of the references that correspond to matches with protected files in the search results.

Another technique to modify the search results in 704 is to modify information for the references corresponding to matches with protected files so that they point to, for examples, an IP address that is invalid, or an IP address for a computer that does not host the requested content, or an IP address for a computer that is not even running the client application software for the decentralized network.

Another technique to modify the search results in 704 is to modify information for the references corresponding to matches with protected files so that they point to alternative files on their respective host nodes (i.e., nodes identified in the search results as having the protected files available for file sharing). Selection of the alternative files in this case may be made by random or non-random selection of non-protected files (i.e., files, documents or programs that the Software Agent is not chartered to protect).

Another technique to modify the search results in 704 is to modify information for the references corresponding to matches with protected files so that they point to one or more alternative files residing on a Controlled Node. Selection of the alternative files may be made by random or non-random selection of files on a Controlled Node, as long as the alternative files being pointed to are not protected files. The Controlled Node may be a Software Agent or another node that is controlled by the Central Coordinating Authority 601.

Since the node is controlled in this case, there is flexibility in the form and/or content of the alternative file being pointed to. For example, the alternative file may be a synthesized decoy, or another file that is freely distributable, or a rights managed version of the protected file (i.e., one that has added controls and/or features to make it compatible with a digital rights management system).

Synthesis of Decoy Files

Decoys are used to impersonate protected files. In particular, Decoys are files having the same properties such as filename and metadata as the files that they are impersonating, but have different content. Hash values provided by the Decoys, however, generally match their actual content, not the content of the files that they are impersonating. The following describes ways in which decoys can be algorithmically synthesized to impersonate protected audio, video, application, image and document files.

For all file types, the title of the synthesized decoy will be a random combinatorial reordering of words and phrases from the title of the protected file. The mouse over property of the file will be the same as the title.

For audio files, the content can be white noise or an anti-piracy message. The MIME type will be randomly selected from one of the commonly used types for audio (such as wave, or aiff). The length of the file is chosen at random from a range that corresponds to the size range of the known instances of the file on the Network.

For video files, the content will be snow or white noise. The MIME type will be randomly selected from one of the commonly used types for video (such as mpeg, avi, or quicktime). The length of the file is also chosen at random from a range that corresponds to the size range of the known instances of the file on the Network.

For applications, the content will be a “no operation” or NOP executable that simply terminates when executed. The type will be randomly selected from one of the commonly used types (such as ZIP).

For image files, the content will be snow or an anti-piracy statement. The MIME type will be randomly selected from one of the commonly used types for images (such as jpg, tif, or gif). The color depth and resolution are also randomly chosen (e.g., 1600×800 resolution, 16 bit depth).

For documents, the content is blank and the MIME type is randomly selected from one of the commonly used types for documents (such as zip, pdf, doc, ppt, rtf, or html).

As just one example, the algorithmically synthesized decoy for a protected audio file for Madonna's Ray of Life track could include a title Ray of Life Track by Madonna. The content of the file, however, could be just white noise. The MIME type could be mp3 (or any of the common audio mime types) and the length of the audio file could be 3.5 minutes. Mouse over on the decoy would display the file title which would closely match the title of the protected file.

In addition to, or in lieu of, modifying the search results in 704, the interdiction system of the present invention may also perform other activities for interdicting unauthorized copying in a decentralized network.

Nodal Quarantining

One such activity is nodal quarantining, wherein a node to be quarantined is surrounded with Software Agents by, for example, the Central Control Authority 601. Using nodal quarantining, a node that is identified as having protected files available for file sharing can be effectively eliminated from the decentralized network by making it “invisible” to other nodes on the decentralized network or its file sharing activity restricted, but not completely eliminated, so as to interdict unauthorized copying of protected files while allowing it to share non-protected files with other nodes in the decentralized network.

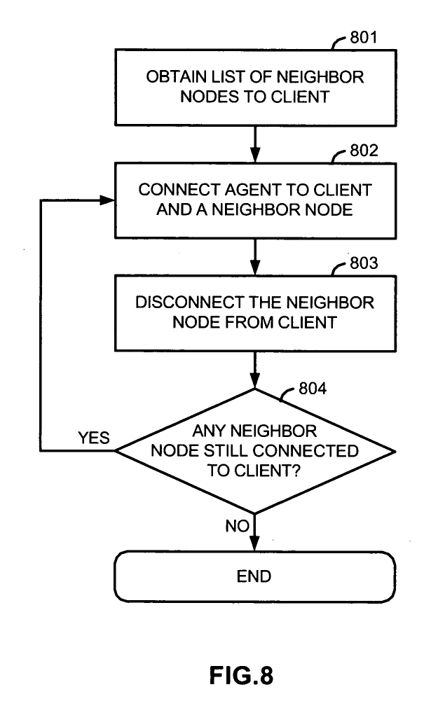

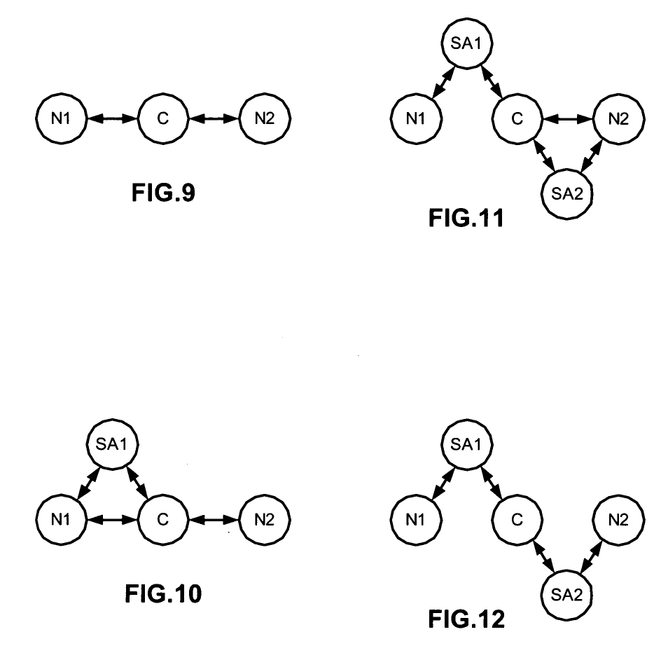

FIG. 8 illustrates a flow diagram of a method for quarantining a node, and FIGS. 9-12 illustrate a simple step-by-step example of the method using node diagrams. In 801, after identifying a node C to be quarantined, a list of its immediate neighbor nodes, N1 and N2, is obtained from that node (FIG. 9). In 802, a Software Agent SA1 is connected to a neighbor node N1 and the node C (FIG. 10). In 803, that neighbor node N1 is then disconnected from the node C (left side of FIG. 11).

Depending upon the capabilities and protocol of the decentralized network, the neighbor node N1 may be disconnected using any one of numerous different techniques such as:
1) issuing a “Disconnect from node C” message to node N1, or vice versa;
2) issuing a “Disconnect from the Network” message to node N1;
3) issuing a message to node C, purporting to be from the neighbor node N1, indicating that node N1 is now disconnecting, or vice versa;
4) issuing a message to node N1 that violates the agreed upon connection protocol between node N1 and node C, thus inducing node N1 to abandon the connection, or vice versa;
5) attaching a very large number of Software Agents to node C so that its capacity or quota of immediate neighbors is exceeded, thus inducing node C to disconnect from one or more of its immediate neighbor nodes until node N1 is disconnected;
6) attaching a very large number of Software Agents to node C so that its capacity or quota of immediate neighbors is exceeded, thus inducing node C to transfer connections for one or more of its immediate neighbor nodes to a single neighbor node until node N1 is disconnected from node C;
7) overwhelming the capacity of node C's port, socket or connection to node N1 by bombarding it with messages or requests that it must parse, act upon, or otherwise process; or
8) eliminating or disconnecting N1 from the decentralized network altogether by exploiting a known defect in the client software application for the decentralized network or underlying client operating system running on the node N1 (e.g., overrun the stack).

It is noted with regards to this last disconnect technique that documentation of such bugs is available in the public domain, albeit ephemerally, for most software clients of popular, large-scale distributed networks.

In 804, the method determines whether there is a neighbor node that is still directly connected to the node to be quarantined. In this example, the answer is YES, so the method loops back to 802, and another Software Agent SA2 is connected to a neighbor node N2 and the node C (right side of FIG. 11). In 803, the neighbor node N2 is then disconnected from the node to be quarantined (FIG. 12). Then again in 804, the method determines whether there is another neighbor node connected to the node to be quarantined. This time, however, the answer is N0, so the method terminates.

File Impersonation

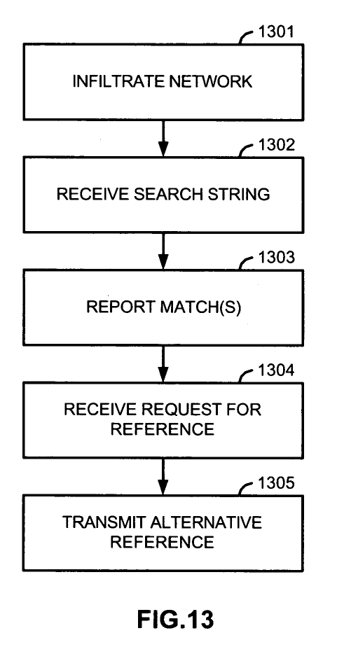

Another activity for interdicting unauthorized copying in a decentralized network is file impersonation. For example, FIG. 13 illustrates a flow diagram of a method for interdicting unauthorized copying in a decentralized network through file impersonation. In 1301, a Software Agent infiltrates a decentralized network resembling or masquerading as a node along with other Software Agents as described in reference to FIG. 6. The node in this case may be any type of node in either a non-hierarchical or hierarchical decentralized network. In 1302, the Software Agent receives a search string just like other nodes in the decentralized network, and in 1303, it reports matches for protected files satisfying the search string along with attributes that would qualify it as a top choice or source for the matches in the decentralized network.

In 1304, the Software Agent receives a request for one of the reported matches, and in 1305, it sends an alternative file instead of the actually requested file. The alternative file in this case may be a synthesized decoy file, or a spoof file, or a file that is freely distributable, or a rights-managed version of the matched protected file.

File Transfer Attenuation

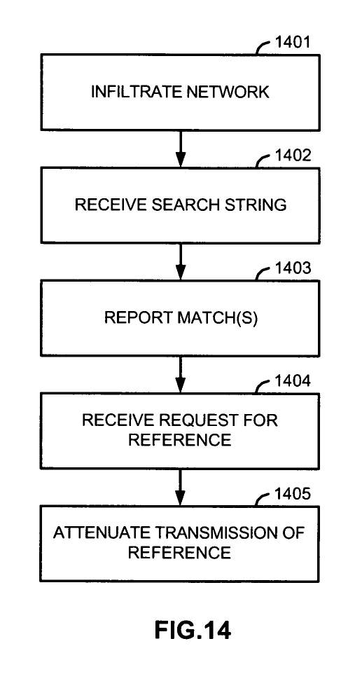

Another activity for interdicting unauthorized copying in a decentralized network is file transfer attenuation. For example, FIG. 14 illustrates a flow diagram of a method for interdicting unauthorized copying in a decentralized network through file transfer attenuation, wherein 1401-1404 are performed in the same manner as described in reference to 1301-1304. In 1405, however, in addition to transmitting an alternative file, the method attenuates the transmission so that its transmission rate starts off fast, then as the download goes on, the transmission rate slows down. By the time the transmission rate slows down a lot, the user of the client node requesting the file has got most of the file so he or she will be reluctant to cancel the download at that point. Eventually, however, the transmission rate will slow down to such a trickle that the user will probably become extremely unhappy with the download progress and consequently, cancel it at that point. In this case, the download will not time out so the user must explicitly cancel it in order to terminate the transmission. Alternatively, the transmission may be automatically terminated after a certain percentage such as 95% of the file has been transmitted.

Another technique for interdicting unauthorized copying in a decentralized network is hash spoofing. Although discussed separately here, forms of hash spoofing can also be used in the search results modification method described in reference to FIG. 7 as well as the file impersonation method described in reference to FIG. 13.

Hash Spoofing

In most decentralized peer-to-peer file sharing networks, whether hierarchical or non-hierarchical, each unique file is given an identification code to uniquely identify its content. Commonly, this code is a hash value generated through a cryptographic hash algorithm (such as MD-4, MD-5, SHA-1, SHA-64, etc.) of all or a subset of the file's content. This hash mechanism is used by some decentralized networks to facilitate resuming downloads which have been interrupted for some reason before completion, or for multi-source downloading which can be used to greatly improve the reliability and speed of file downloads.

A client node sends out a search string on a decentralized network, and gets search results back along with their hashes. The file that the user of the client node wishes to download, may reside on more than one node in the decentralized network as evidenced by identical hashes. If the client node has its download interrupted for some reason, it may resume its download at a later time by finding another node having the file as identified by an identical hash value, and downloading the rest of the file at that time from that node. In addition, if the client node wants to download a file with many sources on the decentralized network and it knows that all of these sources have exactly the same content (as evidenced by their same hash values), the client node can split the file content into segments and request a few segments from each of the sources.

Once the downloads are completed, the client node then can verify that the hash given to it in the search results is identical to the hash calculated using the file content that was downloaded. If the two match, then downloading was successful. On the other hand, if they do not match, then the downloaded file is said to be corrupt, and the client node will either automatically delete it or flag it as corrupt and ask the user what to do with it.

Hash spoofing can be used for interdicting unauthorized copying where such interruption/resumption and multi-source downloading is being used in a decentralized network. In the interdiction method described in reference to FIG. 7, the Software Agent may modify the search results so as to replace a link to (or address of) a file to be protected with either a link to a non-existent file along with a reported hash value that doesn't correspond to any file in the decentralized network, or a link to a spoof file along with a reported hash value matching that of the file whose link is being replaced. In the first case, the client node will try to find the non-existent file, but will be unsuccessful, because the file doesn't exist. The client node may also try to find other files with the same hash value as the non-existent file for download, but will never be able to since there are no files in the decentralized network that correspond to the hash value.

In the second case, when the Software Agent receives a request for a protected file, or a segment of the protected file in the case of a multi-source download, the spoof file or a portion thereof is transmitted instead of the requested file or segment of the file. After the client node has completed downloading the file, or all segments from its sources in the case of multi-source downloading, the hash will be calculated and a mismatch will be detected at that time (i.e., the file will be corrupted), because the hash value of the spoof file or segment thereof is different than that reported.

Still other techniques for interdicting unauthorized copying in a decentralized network using the plurality of Software Agents, Central Coordinating Authority, and Query Matcher as described herein can also be readily conceived and are fully contemplated to be within the full scope of the present invention.

Although the various aspects of the present invention have been described with respect to a preferred embodiment, it will be understood that the invention is entitled to full protection within the full scope of the appended claims.

1. A system for interdicting unauthorized copying in a decentralized network comprising:
a plurality of software agents masquerading as nodes in a decentralized network; and
a query matcher that receives search results from the plurality of software agents, and reports matches of the search results with protected files back to the plurality of software agents so that the software agents can interdict unauthorized copying of the protected files in the decentralized network.

2. The system according to claim 1, wherein the plurality of software agents reside on one or more computers while communicating to the decentralized network through individually assigned ports.

3. The system according to claim 2, wherein the assigned ports have corresponding IP addresses that change in a manner so that detection of the plurality of software agents as unauthorized masqueraders of nodes in the decentralized network is made difficult.

4. The system according to claim 2, wherein the number and geographical locations of the one or more computers is determined by the number and geographical distribution of nodes in the decentralized network.

5. The system according to claim 1, wherein the query matcher has a database including metadata for the protected files.

6. The system according to claim 1, further comprising a central coordinating authority coordinating activities of the plurality of software agents so as to interdict unauthorized copying in the decentralized network.

7. The system according to claim 6, wherein the central coordinating authority sends instructions to the plurality of software agents specifying actions to be taken when the plurality of software agents receive matches of the search results with protected files back from the query matcher.

8. The system according to claim 7, wherein the instructions sent by the central coordinating authority include an instruction to generate modified search results by deleting at least a subset of references corresponding to the matches of the search results, and forward the modified search results through the decentralized network.

9. The system according to claim 7, wherein the instructions sent by the central coordinating authority include an instruction to generate modified search results by modifying at least a subset of references corresponding to the matches of the search results so as to point to one or more IP addresses that are invalid, and forward the modified search results through the decentralized network.

10. The system according to claim 7, wherein the instructions sent by the central coordinating authority include an instruction to generate modified search results by modifying at least a subset of references corresponding to the matches of the search results so as to point to one or more IP addresses of nodes that do not have copies of the subset of references, and forward the modified search results through the decentralized network.

11. The system according to claim 7, wherein the instructions sent by the central coordinating authority include an instruction to generate modified search results by modifying at least a subset of references corresponding to the matches of the search results so as to point to one or more IP addresses of nodes that are not connected to the decentralized network, and forward the modified search results through the decentralized network.

12. The system according to claim 7, wherein the instructions sent by the central coordinating authority include an instruction to generate modified search results by modifying at least a subset of references corresponding to the matches of the search results so as to point to alternative files, and forward the modified search results through the decentralized network.

13. The system according to claim 12, wherein the alternative files include at least one randomly selected file residing on a node upon which one of the matches of the search results resides.

14. The system according to claim 12, wherein the alternative files include at least one decoy file residing on a host node controlled by the central coordinating authority.

15. The system according to claim 12, wherein the alternative files include at least one randomly selected file residing on a host node controlled by the central coordinating authority.

16. The system according to claim 12, wherein the alternative files include at least one rights-managed version of the matches.

17. The system according to claim 7, wherein the instructions sent by the central coordinating authority include an instruction to send an alternative file to a client node when a request for a protected file is received from the client node.

18. The system according to claim 17, wherein the alternative file is a decoy.

19. The system according to claim 18, wherein the decoy is an audio file containing white noise.

20. The system according to claim 18, wherein the decoy is a video file containing white noise.

21. The system according to claim 18, wherein the decoy is an application containing a NOP executable that terminates the application when executed.

22. The system according to claim 18, wherein the decoy is an image file containing snow.

23. The system according to claim 18, wherein the decoy is a document with blank contents.

24. The system according to claim 18, wherein the decoy contains an anti-piracy message.

25. The system according to claim 17, wherein the alternative file is a rights managed version of the protected file.

26. The system according to claim 17, wherein the instructions sent by the central coordinating authority include an instruction to transmit the alternative file such that the transmission rate slows down during the transmission.

27. The system according to claim 17, wherein the instructions sent by the central coordinating authority include an instruction to transmit the alternative file such that the transmission terminates automatically after most, but not all of the alternative file has been downloaded.

28. The system according to claim 7, wherein the instructions sent by the central coordinating authority include an instruction to modify at least one reference corresponding to a match in the search results so as to point to a non-existent file along with a reported hash value that does not correspond to any file in the decentralized network instead of the at least one reference.

29. The system according to claim 7, wherein the instructions sent by the central coordinating authority include an instruction to modify a reference corresponding to a match in the search results so as to point to a spoof file instead of the reference and report a hash value matching that of the reference even though the contents of the spoof file do not exactly match that of the reference.

30. The system according to claim 1, wherein the decentralized network comprises:
a plurality of nodes; and
a plurality of supernodes individually having higher resources than each of the plurality of nodes so that a search string initiated from one of the plurality of nodes is first routed to one of the plurality of supernodes.

31. The system according to claim 30, wherein the plurality of software agents inform their respective supernodes that they have copies of protected files and claim node attributes so that the plurality of software agents will be selected as top matches by their respective supernodes for search strings indicating the protected files.

32. The system according to claim 30, wherein the plurality of software agents inform the decentralized network that they are supernodes.

33. The system according to claim 30, wherein the plurality of software agents report to the decentralized network that they possess attributes that qualify them as supernodes under the protocol of the decentralized network.

34. A method for interdicting unauthorized copying in a decentralized network, comprising:
infiltrating a decentralized network with a plurality of software agents masquerading as nodes so as to intercept communications related to search queries;
identifying references to protected files in the communications; and
interdicting unauthorized copying of the protected files with respect to the communications.

35. The method according to claim 34, wherein the decentralized network is an hierarchical network with supernodes and regular nodes, and the plurality of software agents masquerade as regular nodes that inform their respective supernodes that they have copies of protected files and claim node attributes so that the plurality of software agents will be selected as top matches by their respective supernodes for search strings indicating the protected files.

36. The method according to claim 34, wherein the decentralized network is an hierarchical network with supernodes and regular nodes, and the plurality of software agents inform the decentralized network that they are supernodes according to the protocol of the decentralized network.

37. The method according to claim 34, wherein the decentralized network is an hierarchical network with supernodes and regular nodes, and the plurality of software agents report to the decentralized network that they possess attributes that qualify them as supernodes under the protocol of the decentralized network.

38. The method according to claim 34, wherein the communications are search results, and the interdicting of unauthorized copying comprises: generating modified search results by deleting at least a subset of references corresponding to the protected files in the search results, and forwarding the modified search results through the decentralized network.

39. The method according to claim 34, wherein the communications are search results, and the interdicting of unauthorized copying comprises: generating modified search results by modifying at least a subset of references corresponding to the protected files in the search results to point to one or more invalid IP addresses, and forwarding the modified search results through the decentralized network.

40. The method according to claim 34, wherein the communications are search results, and the interdicting of unauthorized copying comprises: generating modified search results by modifying at least a subset of references corresponding to the protected files in the search results to point to one or more IP addresses that do not host the subset of references, and forwarding the modified search results through the decentralized network.

41. The method according to claim 34, wherein the communications are search results, and the interdicting of unauthorized copying comprises: generating modified search results by modifying at least a subset of references corresponding to the protected files in the search results to point to one or more IP addresses that are not connected to the decentralized network, and forwarding the modified search results through the decentralized network.

42. The method according to claim 34, wherein the communications are search results, and the interdicting of unauthorized copying comprises: generating modified search results by modifying at least a subset of references corresponding to the protected files in the search results to point to alternative files, and forwarding the modified search results through the decentralized network.

43. The method according to claim 42, wherein the alternative files include at least one synthesized decoy file.

44. The method according to claim 42, wherein the alternative files include at least one rights-managed version of one of the protected files referenced in the search results.

45. The method according to claim 34, wherein one of the communications is a request from a client node to one of the plurality of software agents for a copy of a protected file, and further comprising: sending an alternative file to the client node in lieu of the copy of the protected file.

46. The method according to claim 45, wherein the alternative file is a synthesized decoy file.

47. The method according to claim 46, further comprising: synthesizing the decoy file by filling the decoy file with white noise.

48. The method according to claim 46, further comprising: synthesizing the decoy file by filling the contents of the decoy file with an anti-piracy message.

49. The method according to claim 46, wherein the protected file is an application program, and further comprising: synthesizing the decoy file by including a NOP executable that terminates when executed.

50. The method according to claim 45, wherein the alternative file is a rights-managed version of the protected file.

51. The method according to claim 45, wherein the sending an alternative file comprises: transmitting the alternative file at a transmission rate that slows down during the transmission.

52. The method according to claim 45, wherein the sending an alternative file comprises: transmitting the alternative file in a manner such that the transmission terminates automatically after most, but not all of the alternative file has been downloaded.

53. The method according to claim 34, wherein one of the communications is search results, and the interdicting of unauthorized copying comprises: generating modified search results by providing a pointer to a non-existent file instead of another pointer to a reference in the search results that matches a protected file, and forwarding the modified search results through the decentralized network.

54. The method according to claim 53, wherein a reported hash value that does not match any file in the decentralized network is provided along with the pointer to the non-existent file.

55. The method according to claim 34, wherein one of the communications is search results, and the interdicting of unauthorized copying comprises: generating modified search results by replacing a pointer to a reference in the search results that matches a protected file with another pointer to a spoof file along with a hash value matching that of the reference, and forwarding the modified search results through the decentralized network.

56. The method according to claim 34, wherein one of the communications is a request to one of the plurality of software agents from a client node for at least a segment of a protected file, and the interdicting of unauthorized copying comprises: transmitting data to the client node in response to the request so that a corrupted file is detected upon completion of downloading of the protected file to the client node.

57. A method for interdicting unauthorized copying in a decentralized network, comprising: interposing one or more software agents resembling nodes between a client node and neighboring nodes of the client node in a decentralized network such that all communications related to search queries must pass through the one or more software agents so as to allow the one or more software agents to interdict unauthorized copying by the client node in the decentralized network.

58. The method according to claim 57, wherein each of the neighboring nodes is directly connected to the client node, and the interposing one or more software agents comprises connecting the one or more software agents to the client computer so as to cause the client node to disconnect from the neighboring nodes and only be directly connected to the one or more software agents.

59. The method according to claim 57, wherein each of the neighboring nodes is directly connected to the client node in the decentralized network, and the interposing one or more software agents comprises for each of the neighboring nodes: connecting a corresponding one of the one or more software agents to that neighboring node and to the client node; and causing that neighboring node to be disconnected from the client node.

60. The method according to claim 59, wherein the causing that neighboring node to be disconnected from the client node comprises: issuing a message to that neighboring node to disconnect from the client node.

61. The method according to claim 59, wherein the causing that neighboring node to be disconnected from the client node comprises: issuing a message to the client node to disconnect from that neighboring node.

62. The method according to claim 59, wherein the causing that neighboring node to be disconnected from the client node comprises: issuing a message to that neighboring node to disconnect from the decentralized network.

63. The method according to claim 59, wherein the causing that neighboring node to be disconnected from the client node comprises: issuing a message purported to be from that neighboring node to the client node indicating that that neighboring node is disconnecting from the client node.

64. The method according to claim 59, wherein the causing that neighboring node to be disconnected from the client node comprises: issuing a message purported to be from the client node to that neighboring node indicating that the client node is disconnecting from that neighboring node.

65. The method according to claim 59, wherein the causing that neighboring node to be disconnected from the client node comprises: issuing a message to that neighboring node that violates an agreed upon protocol between the client node and that neighboring node so as to cause that neighboring node to abandon the connection with the client node.

66. The method according to claim 59, wherein the causing that neighboring node to be disconnected from the client node comprises: issuing a message to the client node that violates an agreed upon protocol between the client node and that neighboring node so as to cause the client node to abandon the connection with that neighboring node.

67. The method according to claim 59, wherein the causing that neighboring node to be disconnected from the client node comprises: connecting additional software agents resembling nodes to the client computer until the client computer disconnects from that neighboring node.

68. The method according to claim 67, wherein the connecting additional software agents comprises: causing the client computer to transfer a connection to that neighboring node to another neighboring node so as to no longer be directly connected to that neighboring node.

69. The method according to claim 59, wherein the causing that neighboring node to be disconnected from the client node comprises: bombarding a socket connection connecting the client node to that neighboring node with communications so as to cause the socket connection to be terminated.

70. The method according to claim 59, wherein the causing that neighboring node to be disconnected from the client node comprises: causing software running on that neighboring node and responsible for maintaining a connection with the client node to experience a known defect causing that neighboring node to be disconnected from the client node.
